(19) United States
(12) Patent Application Publication
(10) Pub. No.: US 2009/0040522 A1
(43) Pub. Date: Feb. 12, 2009

(54) Measuring Apparatus and Measuring Method

(75) Inventors: Yukitoshi Otani, Tokyo (JP); Naoki Asato, Tokyo (JP); Toshitaka Wakayama, Tokyo (JP)

Correspondence Address: Reed Smith, 3110 Fairview Park Drive, Suite1400, Falls Church, VA, 22042, US

(73) Assignee: NATIONAL UNIVERSITY CORPORATION TOKYO UNIVERSITY OF AGRICULTURE AND TECHNOLOGY

(21) Appl. No.: 12/224,491

(22) PCT Filed: Feb. 16, 2007
(86) PCT No.: PCT/JP2007/052844

§ 371 Date: Oct. 17, 2008

(30) Foreign Application Priority Data
Feb. 28, 2006 (JP) 2006-054153

(51) Int. Cl. G01N 21/21

(52) U.S. Cl. 356/367

(57) ABSTRACT

A measuring apparatus that measures the polarization state of analysis target light includes a modulation section 20 that includes a retarder 22 and an analyzer 24, a light intensity information acquisition section 30 that acquires light intensity information about modulated light obtained by modulating the analysis target light at the modulation section, and a calculation section 50 that calculates a polarization characteristic element of the analysis target light based on the light intensity information. The light intensity information acquisition section acquires the light intensity information about first modulated light to Nth modulated light respectively obtained by modulating the analysis target light at the modulation section set under first to Nth principal axis direction conditions which differ in the principal axis direction of at least one of the retarder and the analyzer. The calculation section calculates the polarization characteristic element based on a light intensity theoretical expression for the first modulated light to the Nth modulated light and first light intensity information to Nth light intensity information.

### TECHNICAL FIELD

The present invention relates to a measuring apparatus that measures a polarization state of analysis target light and a measuring method for measuring a polarization state of analysis target light.

### BACKGROUND ART

In recent years, new liquid crystal display materials have been extensively studied and developed. Therefore, an increase in accuracy has been desired for product inspection measuring methods. A circular polarizer film is known as a polymer film used as a liquid crystal display material. The circular polarizer film can compensate for a reduction in viewing angle due to the birefringence or optical activity of a liquid crystal or a deterioration in product due to coloration. Since birefringence and optical activity have wavelength dependence, evaluation corresponding to each wavelength is necessary. As the evaluation method, a rotating analyzer method or a rotating phaser method has been used to measure the ellipticity. As documents that disclose these technologies, JP-A-2005-292028 and R. M. A. Azzam, Ellipsometry and polarized light, (1976) are known.

### DISCLOSURE OF THE INVENTION

However, since the ellipticity is given by an arc sine function when using the rotating analyzer method, the accuracy deteriorates when the retardation of the measurement sample is about 90°. When using the rotating phaser method, since it is necessary to replace the phaser according to the measurement wavelength, it is difficult to achieve efficient evaluation corresponding to each wavelength.

An objective of the invention is to provide a measuring apparatus and a measuring method that can accurately analyze a polarization state of analysis target light without replacing a phaser according to wavelength.

(1) According to the invention, there is provided a measuring apparatus that measures a polarization state of analysis target light, the measuring apparatus comprising:

a modulation section that modulates the analysis target light, the modulation section including a retarder and an analyzer that can be rotated;

a light intensity information acquisition section that acquires light intensity information about modulated light obtained by modulating the analysis target light at the modulation section; and

a calculation section that performs a calculation process that calculates a polarization characteristic element of the analysis target light based on the light intensity information about the modulated light,

the modulation section being configured so that the analysis target light passes through the retarder and then passes through the analyzer;

the light intensity information acquisition section acquiring the light intensity information about first modulated light to Nth (N is an integer equal to or larger than two) modulated light obtained by modulating the analysis target light at the modulation section set under first to Nth principal axis direction conditions in which the principal axis direction of the retarder and the principal axis direction of the analyzer satisfy a given relationship and which differ in the principal axis direction of at least one of the retarder and the analyzer; and

the calculation section calculating the polarization characteristic element based on a light intensity theoretical expression for the first modulated light to the Nth modulated light and the light intensity information about the first modulated light to the Nth modulated light, the light intensity theoretical expression reflecting the polarization characteristic element of the analysis target light and the principal axis direction condition for the modulation section.

In the measuring apparatus according to the invention, the theoretical expression for the light intensity of the modulated light acquired by the light intensity information acquisition section reflects the polarization characteristic element of the analysis target light and the principal axis direction condition for the modulation section. Therefore, the polarization characteristic element of the analysis target light can be calculated by utilizing the theoretical expression for the light intensity of the modulated light and the measured value.

Specifically, according to the invention, a measuring apparatus that can accurately analyze the polarization state of the analysis target light without replacing the phaser according to wavelength of the analysis target light can be provided. According to the invention, since the measuring apparatus can be formed utilizing a simple drive system that merely rotates the retarder and the analyzer, a measuring apparatus with high measurement efficiency and high measurement accuracy can be provided.

The light intensity information about the modulated light may be obtained by analyzing the modulated light. The first to Nth principal axis direction conditions satisfied by the modulation section may be selected according to the light intensity information analysis method. Various methods such as a Fourier analysis method have been known as the light intensity information analysis method, and data appropriate for analysis may differ depending on the analysis method. In the invention, the first to Nth principal axis direction conditions may be set so that data appropriate for the selected analysis method can be acquired.

When the principal axis direction of the retarder is referred to as theta₁ and the principal axis direction of the analyzer is referred to as theta₂, theta₁ and theta₂ may satisfy the conditions 2theta₁-2theta₂≠0, 4theta₁-2theta₂≠0, and 2theta₁-2theta₂≠4theta₁-2theta₂≠2theta₂. According to this configuration, all of the Stokes parameters can be calculated by a Fourier analysis process.

The measuring apparatus according to the invention may include an optical system which includes a light source and a light-receiving section and in which the modulation section is disposed in an optical path that connects the light source and the light-receiving section. In this case, the optical system may include a sample disposed between the light source and the modulation section in the optical path. The measuring apparatus may be configured as a measuring apparatus that measures the optical characteristic elements (e.g., retardation, principal axis direction, optical activity, Stokes parameters, Mueller matrix elements, and Jones matrix elements) of the sample. The optical characteristic elements can be calculated by adjusting the polarization state of light incident on the sample.

(2) According to the invention, there is provided a measuring apparatus that measures a polarization state of analysis target light, the measuring apparatus comprising:

a light intensity information acquisition section that acquires light intensity information about modulated light obtained by modulating the analysis target light at a modulation section, the modulation section including a retarder and an analyzer that can be rotated; and

a calculation section that performs a calculation process that calculates a polarization characteristic element of the analysis target light based on the light intensity information about the modulated light, the modulated light being obtained by causing the analysis target light to pass through the retarder and then pass through the analyzer;

the light intensity information acquisition section acquiring the light intensity information about first modulated light to Nth (N is an integer equal to or larger than two) modulated light obtained by modulating the analysis target light at the modulation section set under first to Nth principal axis direction conditions in which the principal axis direction of the retarder and the principal axis direction of the analyzer satisfy a given relationship and which differ in the principal axis direction of at least one of the retarder and the analyzer; and

the calculation section calculating the polarization characteristic element based on a light intensity theoretical expression for the first modulated light to the Nth modulated light and the light intensity information about the first modulated light to the Nth modulated light, the light intensity theoretical expression reflecting the polarization characteristic element of the analysis target light and the principal axis direction condition for the modulation section.

In the measuring apparatus according to the invention, the theoretical expression for the light intensity of the modulated light acquired by the light intensity information acquisition section reflects the polarization characteristic element of the analysis target light and the principal axis direction condition for the modulation section. Therefore, the polarization characteristic element of the analysis target light can be calculated by utilizing the theoretical expression for the light intensity of the modulated light and the measured value.

Specifically, according to the invention, a measuring apparatus that can accurately analyze the polarization state of the analysis target light without replacing the phaser according to wavelength of the analysis target light can be provided.

The light intensity information about the modulated light may be obtained by analyzing the modulated light. The first to Nth principal axis direction conditions satisfied by the modulation section may be selected according to the light intensity information analysis method. Various methods such as a Fourier analysis method have been known as the light intensity information analysis method, and data appropriate for analysis may differ depending on the analysis method. In the invention, the first to Nth principal axis direction conditions may be set so that data appropriate for the selected analysis method can be acquired.

When the principal axis direction of the retarder is referred to as theta₁ and the principal axis direction of the analyzer is referred to as theta₂, theta₁ and theta₂ may satisfy the conditions 2theta₁-2theta₂≠0, 4theta₁-2theta₂≠0, and 2theta₁-2theta₂≠4theta₁-2theta₂≠2theta₂. According to this configuration, all of the Stokes parameters can be calculated by a Fourier analysis process.

(3) In this measuring apparatus,

when the principal axis direction of the retarder is referred to as theta₁ and the principal axis direction of the analyzer is referred to as theta₂, a Kth (K is an integer from 1 to N) principal axis direction condition (theta₁, theta₂)_{K} for the modulation section may be (180×L×K/N, 180×M×K/N) (where, L and M are integers equal to or larger than one, provided that L≠M, L≠2M, and 2L≠M).

The data analysis (Fourier analysis) accuracy can be improved by setting the principal axis direction of the retarder and the principal axis direction of the analyzer at an equal interval and changing each of the retarder and the analyzer in a band equal to or larger than 180° (360°).

In this measuring apparatus, L may be 2, M may be 6, and N may be 30, for example. The principal axis direction of the retarder and the principal axis direction of the analyzer may include the initial phase in addition to the above condition.

(4) According to the invention, there is provided a measuring apparatus that measures a polarization state of analysis target light, the measuring apparatus comprising:

a modulation section that modulates the analysis target light, the modulation section including a retarder and an analyzer that can be rotated;

a light intensity information acquisition section that acquires light intensity information about modulated light obtained by modulating the analysis target light at the modulation section, the retarder and the analyzer being rotated at a given rotation ratio; and

a calculation section that performs a calculation process that calculates a polarization characteristic element based on the light intensity information about the modulated light,

the modulation section being configured so that the analysis target light passes through the retarder and then passes through the analyzer;

the light intensity information acquisition section acquiring the light intensity information about the modulated light as analog information, the intensity of the modulated light changing successively; and

the calculation section calculating the polarization characteristic element based on a light intensity theoretical expression for the modulated light and the light intensity information about the modulated light, the light intensity theoretical expression reflecting the polarization characteristic element of the analysis target light and an principal axis direction condition for the modulation section.

In the measuring apparatus according to the invention, the theoretical expression for the light intensity of the modulated light acquired by the light intensity information acquisition section reflects the polarization characteristic element of the analysis target light and the principal axis direction condition for the modulation section. Therefore, the polarization characteristic element of the analysis target light can be calculated by utilizing the theoretical expression for the light intensity of the modulated light and the measured value.

Specifically, according to the invention, a measuring apparatus that can accurately analyze the polarization state of the analysis target light without replacing the phaser according to wavelength of the analysis target light can be provided. According to the invention, since the measuring apparatus includes a simple drive system that merely rotates the retarder and the analyzer, a measuring apparatus with high measurement efficiency and high measurement accuracy can be provided.

In the measuring apparatus according to the invention, the rotation ratio of the retarder and the analyzer may be selected according to the light intensity information analysis method. Specifically, the light intensity information about the modulated light can be obtained by analyzing the modulated light. Various methods such as a Fourier analysis method have been known as the light intensity information analysis method, and data appropriate for analysis may differ depending on the analysis method. In the invention, the rotation ratio of the retarder and the analyzer may be set so that data appropriate for the selected analysis method can be acquired.

The measuring apparatus according to the invention may include an optical system which includes a light source and a light-receiving section and in which the modulation section is disposed in an optical path that connects the light source and the light-receiving section. In this case, the optical system may include a sample disposed between the light source and the modulation section in the optical path. The measuring apparatus may be configured as a measuring apparatus that measures the optical characteristic elements (e.g., retardation, principal axis direction, optical activity, Stokes parameters, Mueller matrix elements, and Jones matrix elements) of the sample. The optical characteristic elements can be calculated by adjusting the polarization state of light incident on the sample.

(5) According to the invention, there is provided a measuring apparatus that measures a polarization state of analysis target light, the measuring apparatus comprising:

a light intensity information acquisition section that acquires light intensity information about modulated light obtained by modulating the analysis target light at a modulation section, the modulation section including a retarder and an analyzer that are rotated at a given rotation ratio; and

a calculation section that performs a calculation process that calculates a polarization characteristic element of the analysis target light based on the light intensity information about the modulated light,

the modulated light being obtained by causing the analysis target light to pass through the retarder and then pass through the analyzer;

the light intensity information acquisition section acquiring the light intensity information about the modulated light as analog information, the intensity of the modulated light changing successively; and

the calculation section calculating the polarization characteristic element based on a light intensity theoretical expression for the modulated light and the light intensity information about the modulated light, the light intensity theoretical expression reflecting the polarization characteristic element of the analysis target light and an principal axis direction condition for the modulation section.

In the measuring apparatus according to the invention, the theoretical expression for the light intensity of the modulated light acquired by the light intensity information acquisition section reflects the polarization characteristic element of the analysis target light and the principal axis direction condition for the modulation section. Therefore, the polarization characteristic element of the analysis target light can be calculated by utilizing the theoretical expression for the light intensity of the modulated light and the measured value.

Specifically, according to the invention, a measuring apparatus that can accurately analyze the polarization state of the analysis target light without replacing the phaser according to wavelength of the analysis target light can be provided.

In the measuring apparatus according to the invention, the rotation ratio of the retarder and the analyzer may be selected according to the light intensity information analysis method. Specifically, the light intensity information about the modulated light can be obtained by analyzing the modulated light. Various methods such as a Fourier analysis method have been known as the light intensity information analysis method, and data appropriate for analysis may differ depending on the analysis method. In the invention, the rotation ratio of the retarder and the analyzer may be set so that data appropriate for the selected analysis method can be acquired.

(6) In this measuring apparatus,

the light intensity information acquisition section may acquire the light intensity information about the modulated light obtained by modulating the analysis target light at the modulation section in which the retarder and the analyzer are rotated at a rotation ratio of 1 to 3.

(7) In this measuring apparatus,

the calculation section may calculate the polarization characteristic element based on a plurality of spectral peaks obtained by analyzing the light intensity information acquired by the light intensity information acquisition section and the light intensity theoretical expression.

In this case, DFT or FFT may be used as the light intensity information analysis method, for example.

(8) In this measuring apparatus,

the calculation section may perform a retardation calculation process before calculating the polarization characteristic element, the retardation calculation process calculating the retardation of the retarder based on the light intensity theoretical expression and light intensity information about modulated light obtained by modulating sample light that shows a predetermined polarization state at the modulation section instead of the analysis target light, and then calculate the polarization characteristic element based on the retardation of the retarder calculated by the retardation calculation process.

The retardation of the retarder can be calculated by utilizing this measuring apparatus. The calculation speed can be improved by calculating the retardation of the retarder in advance and calculating the polarization characteristic element utilizing the resulting value.

(9) In this measuring apparatus,

the calculation section may calculate a Stokes parameter of the analysis target light.

(10) In this measuring apparatus,

the calculation section may calculate at least one of the ellipticity and the principal axis direction of the analysis target light.

(11) This measuring apparatus may further comprise:

a first actuator and a second actuator that rotate the retarder and the analyzer;

a first detection section and a second detection section that detect the principal axis directions of the retarder and the analyzer; and

a control signal generation section that generates a control signal that controls the operations of the first actuator and the second actuator,

wherein the control signal generation section may generate the control signal based on detection signals from the first detection section and the second detection section.

(12) According to the invention, there is provided a measuring method that measures a polarization state of analysis target light, the measuring method comprising:

a light intensity information acquisition process that acquires light intensity information about modulated light obtained by modulating the analysis target light at a modulation section, the modulation section including a retarder and an analyzer that can be rotated; and

a calculation process that calculates a polarization characteristic element of the analysis target light based on the light intensity information about the modulated light,

the modulated light being obtained by causing the analysis target light to pass through the retarder and then pass through the analyzer;

the light intensity information acquisition process acquiring the light intensity information about first modulated light to Nth (N is an integer equal to or larger than two) modulated light obtained by modulating the analysis target light at the modulation section set under first to Nth principal axis direction conditions in which the principal axis direction of the retarder and the principal axis direction of the analyzer satisfy a given relationship and which differ in the principal axis direction of at least one of the retarder and the analyzer; and

the calculation process calculating the polarization characteristic element based on a light intensity theoretical expression for the first modulated light to the Nth modulated light and the light intensity information about the first modulated light to the Nth modulated light, the light intensity theoretical expression reflecting the polarization characteristic element of the analysis target light and the principal axis direction condition for the modulation section.

In the measuring method according to the invention, the theoretical expression for the light intensity of the modulated light acquired by the light intensity information acquisition section reflects the polarization characteristic element of the analysis target light and the principal axis direction condition for the modulation section. Therefore, the polarization characteristic element of the analysis target light can be calculated by utilizing the theoretical expression for the light intensity of the modulated light and the measured value.

Specifically, according to the invention, a measuring method that can accurately analyze the polarization state of the analysis target light without replacing the phaser according to wavelength of the analysis target light can be provided.

The light intensity information about the modulated light may be obtained by analyzing the modulated light. The first to Nth principal axis direction conditions satisfied by the modulation section may be selected according to the light intensity information analysis method. Various methods such as a Fourier analysis method have been known as the light intensity information analysis method, and data appropriate for analysis may differ depending on the analysis method. In the invention, the first to Nth principal axis direction conditions may be set so that data appropriate for the selected analysis method can be acquired.

When the principal axis direction of the retarder is referred to as theta₁ and the principal axis direction of the analyzer is referred to as theta₂, theta₁ and theta₂ may satisfy the conditions 2theta₁-2theta₂≠0, 4theta₁-2theta₂≠0, and 2theta₁-2theta₂≠4theta₁-2theta₂≠2theta₂. According to this configuration, all of the Stokes parameters can be calculated by a Fourier analysis process.

(13) In this measuring method,

when the principal axis direction of the retarder is referred to as theta₁ and the principal axis direction of the analyzer is referred to as theta₂, a Kth (K is an integer from 1 to N) principal axis direction condition (theta₁, theta₂)_{K} for the modulation section may be (180×L×K/N, 180×M×K/N) (where, L and M are integers equal to or larger than one, provided that L≠M, L≠2M, and 2L≠M).

The data analysis (Fourier analysis) accuracy can be improved by setting the principal axis direction of the retarder and the principal axis direction of the analyzer at an equal interval and changing each of the retarder and the analyzer in a band equal to or larger than 180° (360°).

In this measuring method, L may be 2, M may be 6, and N may be 30, for example. The principal axis direction of the retarder and the principal axis direction of the analyzer may include the initial phase in addition to the above condition.

(14) According to the invention, there is provided a measuring method that measures a polarization state of analysis target light, the measuring method comprising:

a light intensity information acquisition process that acquires light intensity information about modulated light obtained by modulating the analysis target light at a modulation section in which a retarder and a analyzer are rotated at a given rotation ratio; and

a calculation process that calculates a polarization characteristic element of the analysis target light based on the light intensity information about the modulated light,

the modulated light being obtained by causing the analysis target light to pass through the retarder and then pass through the analyzer;

the light intensity information acquisition process acquiring the light intensity information about the modulated light as analog information, the intensity of the modulated light changing successively; and

the calculation process calculating the polarization characteristic element based on a light intensity theoretical expression for the modulated light and the light intensity information about the modulated light, the light intensity theoretical expression reflecting the polarization characteristic element of the analysis target light and a principal axis direction condition for the modulation section.

In the measuring method according to the invention, the theoretical expression for the light intensity of the modulated light acquired by the light intensity information acquisition section reflects the polarization characteristic element of the analysis target light and the principal axis direction condition for the modulation section. Therefore, the polarization characteristic element of the analysis target light can be calculated by utilizing the theoretical expression for the light intensity of the modulated light and the measured value.

Specifically, according to the invention, a measuring method that can accurately analyze the polarization state of the analysis target light without replacing the phaser according to wavelength of the analysis target light can be provided.

In the measuring method according to the invention, the rotation ratio of the retarder and the analyzer may be selected according to the light intensity information analysis method. Specifically, the light intensity information about the modulated light can be obtained by analyzing the modulated light. Various methods such as a Fourier analysis method have been known as the light intensity information analysis method, and data appropriate for analysis may differ depending on the analysis method. In the invention, the rotation ratio of the retarder and the analyzer may be set so that data appropriate for the selected analysis method can be acquired.

(15) In this measuring method,

the light intensity information acquisition process may acquire the light intensity information about the modulated light obtained by modulating the analysis target light at the modulation section in which the retarder and the analyzer are rotated at a rotation ratio of 1 to 3.

(16) In this measuring method,

the calculation process may calculate the polarization characteristic element based on the light intensity theoretical expression and a plurality of spectral peaks obtained by analyzing the light intensity information acquired by the light intensity information acquisition process.

(17) This measuring method may further comprise:

a retardation calculation process before calculating the polarization characteristic element, the retardation calculation process acquiring light intensity information about modulated light obtained by modulating sample light that shows a predetermined polarization state at the modulation section instead of the analysis target light, and calculating the retardation of the retarder based on the light intensity information and the light intensity theoretical expression,

wherein the calculation process may calculate the polarization characteristic element based on the retardation of the retarder calculated by the retardation calculation process.

According to this measuring method, the retardation of the retarder can be calculated. The calculation speed can be improved by calculating the retardation of the retarder in advance and calculating the polarization characteristic element utilizing the resulting value.

### BRIEF DESCRIPTION OF THE DRAWINGS

FIG. 1 is an explanatory view showing a measuring apparatus according to one embodiment of the invention.

FIG. 2 is a diagram for describing a measuring apparatus according to one embodiment of the invention.

FIG. 3 is a diagram showing an example of functional blocks of a calculation system.

FIG. 4 is a flowchart illustrative of a light intensity information acquisition process.

FIG. 5 is a flowchart illustrative of a polarization characteristic element calculation process.

FIG. 6 is a graph showing an example of light intensity information.

FIG. 7A is a graph showing an example of light intensity information.

FIG. 7B is a graph showing an example of light intensity information.

FIG. 8 is an explanatory view showing a verification experiment.

FIG. 9 is an explanatory view showing a verification experiment.

FIG. 10A is a graph for describing a verification experiment.

FIG. 10B is a graph for describing a verification experiment.

FIG. 10C is a graph for describing a verification experiment.

FIG. 11A is a graph for describing a verification experiment.

FIG. 11B is a graph for describing a verification experiment.

FIG. 11C is a graph for describing a verification experiment.

FIG. 12 is an explanatory view showing a verification experiment.

FIG. 13 is a graph for describing a verification experiment.

FIG. 14 is a graph for describing a verification experiment.

FIG. 15A is a diagram showing viewing angle characteristic evaluation results for a circular polarizer film.

FIG. 15B is a diagram showing viewing angle characteristic evaluation results for a circular polarizer film.

FIG. 15C is a diagram showing viewing angle characteristic evaluation results for a circular polarizer film.

FIG. 15D is a view showing viewing angle characteristic evaluation results for a circular polarizer film.

### BEST MODE FOR CARRYING OUT THE INVENTION

Embodiments of the invention are described below with reference to the drawings. Note that the following embodiments merely exemplify the invention.

The invention is not limited to the following embodiments. The invention includes a configuration in which items described in the following embodiments are combined arbitrarily.

A measuring apparatus 1 that measures the polarization state of light (analysis target light) emitted from a sample 100 is described as a measuring apparatus according to an embodiment to which the invention is applied. Note that the characteristics of the sample 100 which may be applied to the invention are not particularly limited.

### 1. Device Configuration

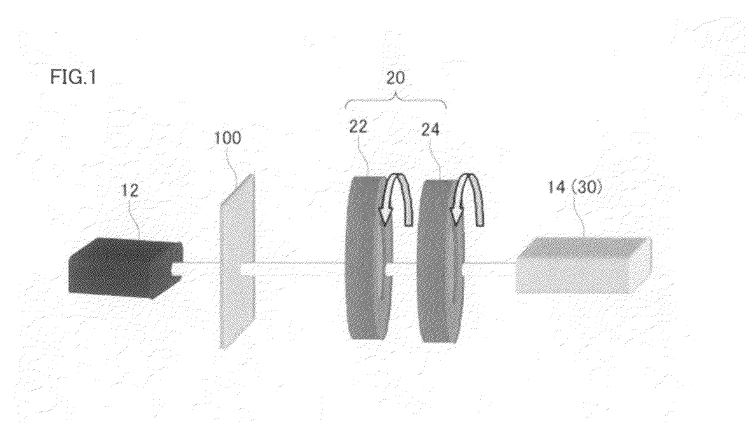

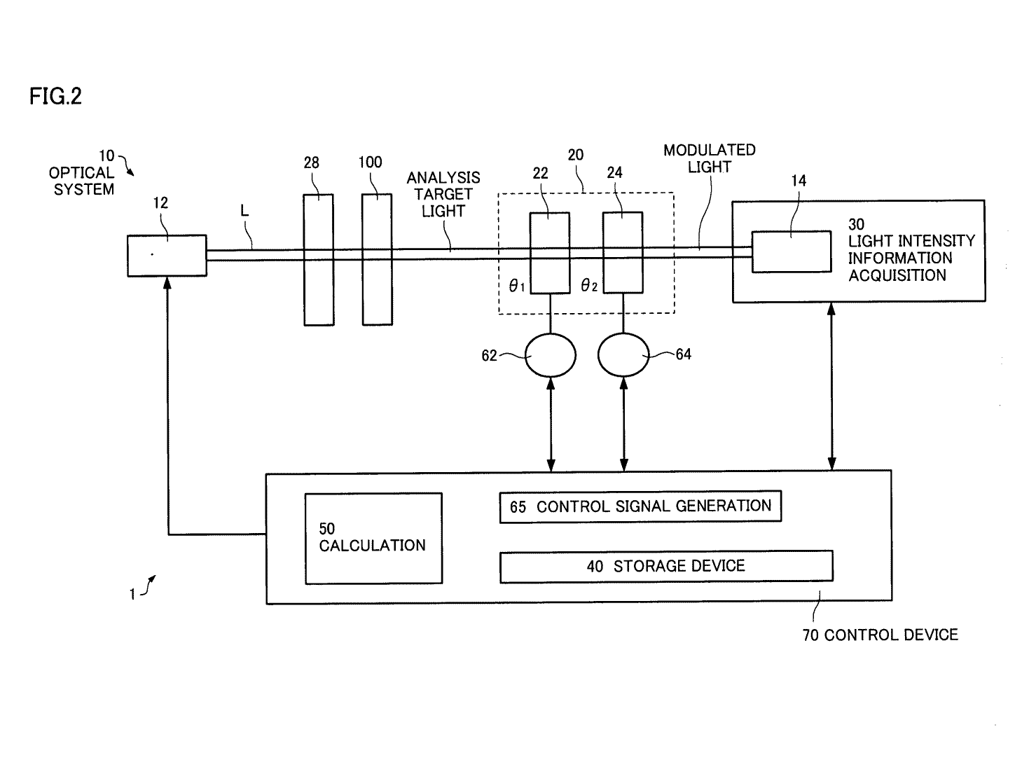

FIGS. 1 and 2 show the configuration of the measuring apparatus 1. FIG. 1 is an explanatory view schematically showing an optical system 10 which may be applied to the invention (measuring apparatus 1), and FIG. 2 is a block diagram illustrative of the configuration of the measuring apparatus 1.

The measuring apparatus 1 includes the optical system 10, a light intensity information acquisition section 30, and a calculation section 50. The light intensity information acquisition section 30 acquires light intensity information about modulated light obtained by modulating the analysis target light (light modulated by the sample 100) at a modulation section 20. Specifically, the light intensity information acquisition section 30 of the measuring apparatus 1 acquires the light intensity information about light (modulated light) emitted from a light source 12 and modulated by optical elements included in the optical system 10 and the sample 10. The calculation section 50 of the measuring apparatus 1 calculates the optical characteristic element of light (analysis target light) modulated by the sample 100 based on a theoretical expression for the light intensity of the modulated light and the light intensity information about the modulated light. The sample 100 may be a substance that allows light to pass through, or may be a substance that reflects light.

The configuration of the measuring apparatus 1 is described below.

### 1-1: Optical System 10

The optical system 10 includes the light source 12 and a light-receiving section 14. The optical system 10 also includes a retarder 22 and an analyzer 24 provided in an optical path L that connects the light source 12 and the light-receiving section 14. The retarder 22 and the analyzer 24 are optical elements that modulate light (analysis target light) emitted from the sample 100. Specifically, the retarder 22 and the analyzer 24 are disposed on the downstream side of the sample 100 in the optical path L. The retarder 22 and the analyzer 24 may be collectively referred to as the modulation section 20. Each element of the optical system 10 is described below.

The optical system 10 includes the light source 12. The light source 12 is a device that generates and emits light. In this embodiment, a device that emits light containing a given wavelength (wave number) band component may be utilized as the light source 12. For example, a white light source such as a halogen lamp may be used as the light source 12. The light source 12 may be a light source that emits light having a given wavelength (wave number). In this case, the light source 12 may be referred to as a light-emitting device that emits monochromatic light. A laser, an SLD, or the like may be used as the light source 12. The light source 12 may be configured so that the wavelength (wave number) of light emitted from the light source 12 can be changed.

The optical system 10 includes the retarder 22. The retarder 22 is an optical element of which the retardation differs depending on the wavelength of light that passes through. Therefore, the polarization state of light that passes through the retarder 22 changes according to its wavelength. In the measuring apparatus 1, light incident on the retarder 22 (modulation section 20) may be referred to as analysis target light. When another optical element is not disposed between the sample 100 and the retarder 22, light emitted from the sample 100 may be referred to as the analysis target light. In the invention, a zero-order retarder is used as the retarder 22.

The optical system 10 includes the analyzer 24. The analyzer 24 is an exit-side polarizer that linearly polarizes light that has passed through the retarder 22 (light emitted from the retarder 22). In the optical system 10, light that has passed through the analyzer 24 (light emitted from the analyzer 24) is incident on the light-receiving section 14.

In the invention, the retarder 22 and the analyzer 24 are collectively referred to as the modulation section 20. The retarder 22 and the analyzer 24 are configured so that the principal axis direction can be changed. The retarder 22 and the analyzer 24 may be configured so that the principal axis direction can be changed by rotating the retarder 22 and the analyzer 24. In the measuring apparatus 1, light obtained by modulating the analysis target light at the modulation section 20 is referred to as modulated light.

The optical system 10 includes the light-receiving section 14. The light-receiving section 14 may be configured to receive light (modulated light) obtained by modulating the analysis target light at the modulation section 20. A CCD may be utilized as the light-receiving section 14, for example.

When the analysis target light (light modulated by the sample 100) is light containing a given band component, the light-receiving section 14 may include a spectroscope and a plurality of light-receiving elements. When the analysis target light is light containing a given band component, the modulated light incident on the light-receiving section 14 also contains the band component. In this case, the light intensity of the modulated light in a plurality of wavelength bands can be measured simultaneously by dispersing the modulated light into a spectrum corresponding to each wavelength using the spectroscope, and measuring the intensity of light having each wavelength using each light-receiving element.

The term “spectroscope” refers to an optical device (optical element) that disperses light (e.g., white light) containing a given band component into a spectrum corresponding to each wavelength. A prism or a diffraction grating may be utilized as the spectroscope, for example. The light-receiving element is an optical device (optical element) that measures the intensity of incident light by photoelectrically converting the incident light, for example.

The optical system 10 may also include a polarizer 28 provided in the optical path L (see FIG. 2). The polarizer 28 is disposed on the upstream side of the sample 100 in the optical path L. Specifically, the optical system 10 is configured so that light emitted from the light source 12 is incident on the sample 100 through the polarizer 28 and the light modulated by the sample 100 is incident on the light-receiving section 14 through the retarder 22 and the analyzer 24 (modulation section 20). Specifically, light obtained by modulating the light emitted from the light source 12 using the polarizer 28 and the sample 100 is the analysis target light of the measuring apparatus 1.

The measuring apparatus 1 according to this embodiment measures the polarization state of light (analysis target light) incident on the modulation section 20 (retarder 22). Therefore, the configuration on the upstream side of the modulation section 20 in the optical path L is not particularly limited. For example, the measuring apparatus 1 may utilize an optical system that does not include the polarizer 28 (see FIG. 1).

### 1-2: Light Intensity Information Acquisition Section 30

The light intensity information acquisition section 30 acquires the light intensity information about the modulated light. Specifically, the light intensity information acquisition section 30 acquires the light intensity information about light (modulated light) obtained by modulating light (analysis target light) incident on the modulation section 20 at the modulation section 20. The process in which the light intensity information acquisition section 30 acquires the light intensity information about the modulated light may be referred to as a light intensity information acquisition process. The light intensity information acquisition section 30 may be configured to acquire the light intensity information about light incident on the light-receiving section 14. The light-receiving section 14 (spectroscope and light-receiving elements) may make up the light intensity information acquisition section 30.

The light intensity information acquisition section 30 of the measuring apparatus 1 acquires the light intensity information about first modulated light to Nth (N is an integer equal to or larger than two) modulated light (i.e., a plurality of types of modulated light) obtained by modulating the analysis target light at the modulation section 20 set under first to Nth principal axis direction conditions in which the principal axis direction of the retarder 22 and the principal axis direction of the analyzer 24 satisfy a given relationship and which differ in the principal axis direction of at least one of the retarder 22 and the analyzer 24.

Specifically, the light intensity information acquisition section 30 acquires first light intensity information to Nth (N is an integer equal to or larger than two) light intensity information (i.e., N pieces of light intensity information). The first light intensity information to the Nth light intensity information indicate the light intensities of the modulated light modulated by the modulation section 20 set under the first to Nth principal axis direction conditions, respectively. The first to Nth principal axis direction conditions differ in at least one of the principal axis directions of the optical elements (retarder 22 and analyzer 24). The first to Nth principal axis direction conditions are set so that the principal axis direction of the retarder 22 and the principal axis direction of the analyzer 24 satisfy a predetermined relationship.

When the principal axis direction of the retarder 22 is referred to as theta₁ and the principal axis direction of the analyzer 24 is referred to as theta₂, the Kth principal axis direction condition (theta₁, theta₂)_{K} may be (180×L×K/N, 180×M×K/N). Land M are integers equal to or larger than one, provided that L is not equal to M. L and M may be even numbers. M may be an odd-numbered multiple of L (L may be an odd-numbered multiple of M). For example, L may be 2, M may be 6, and N may be 30. The data analysis (Fourier analysis) accuracy can be improved by setting the principal axis directions theta₁ and theta₂ at an equal interval and changing each of the retarder 22 and the analyzer 24 in a band equal to or larger than 180° (360°).

In the invention, the modulation section 20 need not necessarily satisfy the above-described principal axis direction condition. Specifically, a known analysis method can be applied to the invention so that the light intensity information may be acquired under an principal axis direction condition that enables acquisition of data appropriate for the selected analysis method. Alternatively, the principal axis direction of the retarder 22 and the principal axis direction of the analyzer 24 may be determined taking the initial phase into consideration in addition to the principal axis direction condition.

The light intensity information acquired by the light intensity information acquisition section 30 may be stored in a storage device 40. The storage device 40 may relate the principal axis direction information (first to Nth principal axis direction conditions) of the modulation section 20 (retarder 22 and analyzer 24) to the first light intensity information to the Nth light intensity information and store them. The calculation section 50 measures the polarization state of the analysis target light based on the light intensity information stored in the storage device 40.

In the measuring apparatus 1, the light intensity information acquisition section 30 acquires the light intensity information about a plurality of types modulated light obtained by modulating the analysis target light at the modulation section 20 that is set so that the principal axis direction of the retarder 22 and the principal axis direction of the analyzer 24 satisfy a given relationship and differs in at least one of the principal axis direction of the retarder 22 and the principal axis direction of the analyzer 24.

Specifically, the light intensity information acquisition section 30 acquires the light intensity information about a plurality of types of modulated light. The plurality of types of modulated light are obtained by modulating the analysis target light at the modulation section 20 that differs in at least one of the principal axis directions of the optical elements (retarder 22 and analyzer 24). The plurality of types of modulated light are obtained by modulating the analysis target light at the modulation section 20 set so that the principal axis direction of the retarder 22 and the principal axis direction of the analyzer 24 satisfy a given relationship.

### 1-3: Calculation Section 50

The calculation section 50 performs a calculation process that measures the polarization state of the analysis target light. The calculation section 50 calculates the polarization characteristic elements of the analysis target light based on a theoretical expression for the light intensity of the modulated light and the light intensity information about the modulated light (i.e., polarization characteristic element calculation process) to measure the polarization state of the analysis target light. The theoretical expression for the light intensity of the modulated light includes a parameter that indicates the polarization state of the analysis target light (described later in detail). Therefore, the parameters (polarization characteristic elements) that indicate the polarization state of the analysis target light can be calculated by utilizing the theoretical expression for the light intensity of the modulated light and the light intensity information about the modulated light. The polarization state of the analysis target light can be measured by calculating the polarization characteristic elements of the analysis target light.

### 1-4: Driver/Detection Section

The measuring apparatus 1 may further include first and second driver/detection sections 62 and 64. The driver section of the driver/detection section is an actuator that variably sets the principal axis direction of the optical element of the optical system. The detection section is a sensor that detects the principal axis direction of the optical element. In the measuring apparatus 1, the first driver/detection section 62 rotates the retarder 22, and detects the principal axis direction of the retarder 22. The second driver/detection section 64 rotates the analyzer 24, and detects the principal axis direction of the analyzer 24.

The measuring apparatus 1 may further include a control signal generation section 65 that controls the operations of the first and second driver/detection sections 62 and 64. For example, the control signal generation section 65 may be configured to generate control signals based on detection signals output from the first and second driver/detection sections 62 and 64 to control the operations of the first and second driver/detection sections 62 and 64.

### 1-5: Control Device 70

The measuring apparatus 1 may include a control device 70. The control device 70 may have a function of controlling the operation of the measuring apparatus 1. Specifically, the control device 70 may control the first and second oparationr/detection sections 62 and 64 to set the principal axis directions of the optical elements, may control the light-emitting operation of the light source 12, and may control the operations of the light intensity information acquisition section 30 and the calculation section 50.

The control device 70 may include the storage device 40 and the calculation section 50. The storage device 40 has a function of temporarily storing various types of data. The storage device 40 may relate the light intensity information about the modulated light to the principal axis direction information about the retarder 22 and the analyzer 24 and store them, for example. The calculation section 50 may calculate the polarization characteristic elements of the analysis target light based on the light intensity information stored in the storage device 40. The control device 70 may also include the control signal generation section 65.

The measuring apparatus 1 can perform a process utilizing a computer using the control device 70 (calculation section 50). The term “computer” used herein refers to a physical device (system) that includes a processor (processing section: CPU or the like), a memory (storage section), an input device, and an output device as basic elements.

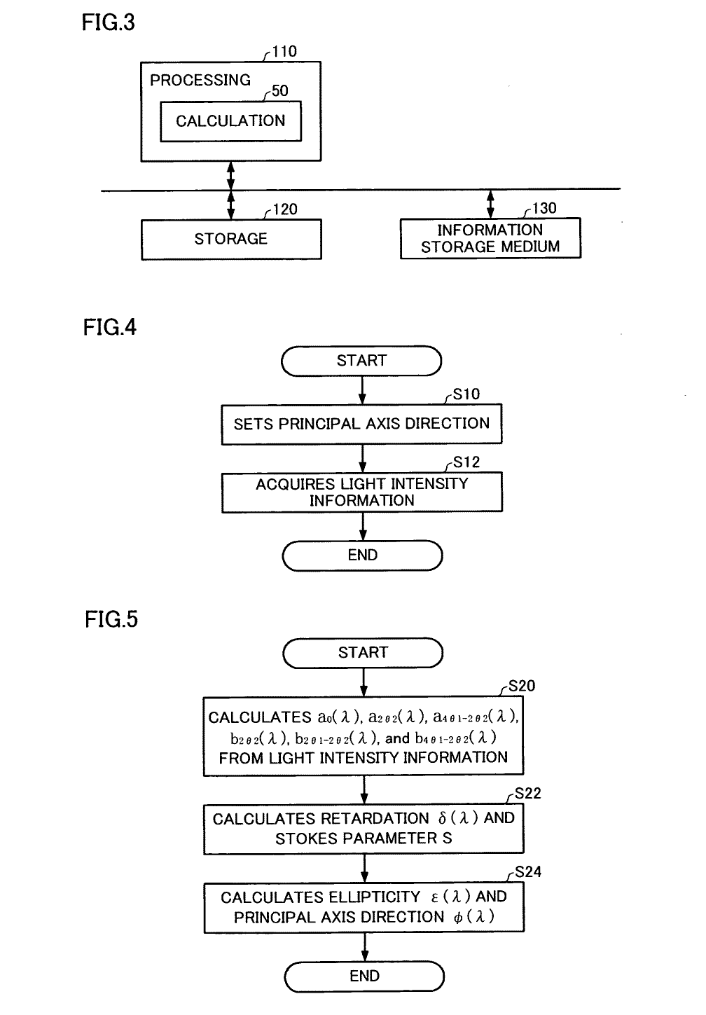

FIG. 3 shows an example of functional blocks of a calculation system that forms the control device 70.

A processing section 110 performs various processes according to this embodiment based on a program (data) stored in an information storage medium 130. Specifically, a program that causes a computer to function as each section according to this embodiment (i.e., a program that causes a computer to execute the process of each section) is stored in the information storage medium 130.

The function of the processing section 110 may be implemented by hardware such as a processor (e.g., CPU or DSP) or ASIC (e.g., gate array), or a program.

A storage section 120 serves as a work area for the processing section and the like. The function of the storage section 120 may be implemented by a RAM or the like.

The information storage medium 130 (computer-readable medium) stores a program, data, and the like. The function of the information storage medium 130 may be implemented by an optical disk (CD or DVD), a magneto-optical disk (MO), a magnetic disk, a hard disk, a magnetic tape, a memory (ROM), or the like. In the measuring apparatus 1, the principal axis direction of the modulation section 20 (retarder 22 and analyzer 24) may be set and the light-emitting operation of the light source 12 be controlled based on a program stored in the information storage medium 130.

### 2. Polarization Characteristic Measurement Principle

The polarization state measurement principle (polarization characteristic element calculation principle) employed in the measuring apparatus according to this embodiment is described below.

### 2-1: Theoretical Expression for Light Intensity of Modulated Light

A Mueller matrix R of the retarder 22 and a Mueller matrix A of the analyzer 24 are expressed as follows.

$$\begin{matrix}R = [ \begin{matrix}1 & 0 & 0 & 0 \\ 0 & 1 - ( 1 - cos δ ( λ ) ) {sin}^{2} 2 {θ}_{1} & ( 1 - cos δ ( λ ) ) sin 2 {θ}_{1} cos 2 {θ}_{1} & - sin δ ( λ ) sin 2 {θ}_{1} \\ 0 & ( 1 - cos δ ( λ ) ) sin 2 {θ}_{1} cos 2 {θ}_{1} & 1 - ( 1 - cos δ ( λ ) ) {cos}^{2} 2 {θ}_{1} & sin δ ( λ ) cos 2 {θ}_{1} \\ 0 & sin δ ( λ ) sin 2 {θ}_{1} & - sin δ ( λ ) cos 2 {θ}_{1} & cos δ ( λ )\end{matrix} ] & ( 1 ) \\ A = \frac{1}{2} [ \begin{matrix}1 & cos 2 {θ}_{2} & sin 2 {θ}_{2} & 0 \\ cos 2 {θ}_{2} & {cos}^{2} 2 {θ}_{2} & cos 2 {θ}_{2} sin 2 {θ}_{2} & 0 \\ sin 2 {θ}_{2} & cos 2 {θ}_{2} sin 2 {θ}_{2} & {sin}^{2} 2 {θ}_{2} & 0 \\ 0 & 0 & 0 & 0\end{matrix} ] & ( 2 )\end{matrix}$$

where, delta(lambda), theta₁, and theta₂ respectively indicate the retardation of the retarder 22, the rotation angle (principal axis direction) of the retarder 22, and the rotation angle (principal axis direction) of the analyzer 24. Since the retardation of the retarder 22 has wavelength dependence, the retardation of the retarder 22 is a function of the wavelength lambda. Specifically, the expression (1) indicates the retardation of the retarder 22 when light having a wavelength lambda is incident on the retarder 22.

When the polarization state Sᵢₙ (Stokes parameter) of light (analysis target light) emitted from the sample 100 is expressed as follows,

$${S}_{in} = [ \begin{matrix}{s}_{0} ( λ ) \\ {s}_{1} ( λ ) \\ {s}_{2} ( λ ) \\ {s}_{3} ( λ )\end{matrix} ] \qquad ( 3 )$$

the polarization state Sₒᵤₜ of modulated light obtained by modulating the analysis target light at the modulation section 20 is expressed as follows.

Sₒᵤₜ=A·R·Sᵢₙ (4)

S₀(lambda) of the polarization state Sᵢₙ indicates light intensity, S₁(lambda) indicates a linearly polarized component, S₂(lambda) indicates a 45-degree polarized component, and S₃(lambda) indicates the vector quantity of a circularly polarized component. S₀(lambda) of the polarization state Sₒᵤₜ indicates a light intensity component of light (modulated light) incident on the light-receiving section 14. The light intensity I(lambda, theta₁, theta₂) of the modulated light is expressed as follows based on the expression (4),

$$I ( λ , {θ}_{1} , {θ}_{2} ) = \frac{{I}_{0} ( λ )}{2} \{ {s}_{0} ( λ ) + {s}_{1} ( λ ) {cos}^{2} \frac{δ ( λ )}{2} cos 2 {θ}_{2} + {s}_{2} ( λ ) {cos}^{2} \frac{δ ( λ )}{2} sin 2 {θ}_{2} - {s}_{3} ( λ ) sin δ ( λ ) sin ( 2 {θ}_{1} - 2 {θ}_{2} ) + {s}_{1} ( λ ) {sin}^{2} \frac{δ ( λ )}{2} cos ( 4 {θ}_{1} - 2 {θ}_{2} ) + {s}_{2} ( λ ) {sin}^{2} \frac{δ ( λ )}{2} sin ( 4 {θ}_{1} - 2 {θ}_{2} ) \} \qquad ( 5 )$$

where, I₀(lambda) indicates a light intensity proportional constant.

The bias component of the light intensity I(lambda, theta1, theta2) and the amplitude components of cos 2theta₂, sin 2theta₂, sin(2theta₁-2theta₂), cos(4theta₁-2theta₂), and sin(4theta₁-2theta₂) are expressed as follows based on the expression (5).

$$\begin{matrix}{a}_{0} ( λ ) = \frac{{I}_{0} ( λ ) {s}_{0} ( λ )}{2} , & ( 6 a ) \\ {a}_{2 {θ}_{2}} ( λ ) = \frac{{I}_{0} ( λ )}{2} {s}_{1} ( λ ) {cos}^{2} \frac{δ ( λ )}{2} , & ( 6 b ) \\ {a}_{4 {θ}_{1} - 2 {θ}_{2}} ( λ ) = \frac{{I}_{0} ( λ )}{2} {s}_{1} ( λ ) {sin}^{2} \frac{δ ( λ )}{2} , & ( 6 c ) \\ {b}_{2 {θ}_{2}} ( λ ) = \frac{{I}_{0} ( λ )}{2} {s}_{2} ( λ ) {cos}^{2} \frac{δ ( λ )}{2} , & ( 6 d ) \\ {b}_{2 {θ}_{1} - 2 {θ}_{2}} ( λ ) = - \frac{{I}_{0} ( λ )}{2} {s}_{3} ( λ ) sin δ ( λ ) , & ( 6 e ) \\ {b}_{4 {θ}_{1} - 2 {θ}_{2}} ( λ ) = \frac{{I}_{0} ( λ )}{2} {s}_{2} ( λ ) {sin}^{2} \frac{δ ( λ )}{2} , & ( 6 f )\end{matrix}$$

The retardation delta(lambda) of the retarder 22 is expressed as follows utilizing the expressions (6a) to (6f).

$$δ ( λ ) = 2 {tan}^{- 1} [ \frac{{a}_{4 {θ}_{1} - 2 {θ}_{2}} ( λ ) + {b}_{4 {θ}_{1} - 2 {θ}_{2}} ( λ )}{{a}_{2 {θ}_{2}} ( λ ) + {b}_{2 {θ}_{2}} ( λ )} ] \qquad ( 7 )$$

Since the left side of each of the expressions (6a) to (6f) can be calculated using the light intensity information (described later), the retardation delta(lambda) can be calculated by substituting these values in the expression (7).

The Stokes parameters s₀(lambda), s₁(lambda), s₂(lambda), and s₃(lambda) of the analysis target light are expressed as follows utilizing the expressions (6a) to (6f).

$$\begin{matrix}{s}_{0} ( λ ) = \frac{2}{{I}_{0} ( λ )} {a}_{0} ( λ ) & ( 8 a ) \\ {s}_{1} ( λ ) = \frac{2}{{I}_{0} ( λ )} ( {a}_{4 {θ}_{1} - 2 {θ}_{2}} ( λ ) + {a}_{2 {θ}_{2}} ( λ ) ) & ( 8 b ) \\ {s}_{2} ( λ ) = \frac{2}{{I}_{0} ( λ )} ( {b}_{2 {θ}_{2 }} ( λ ) - {b}_{4 {θ}_{1} - 2 {θ}_{2}} ( λ ) ) & ( 8 c ) \\ {s}_{3} ( λ ) = \frac{2}{{I}_{0} ( λ )} {b}_{2 {θ}_{1} - 2 {θ}_{2}} ( λ ) ( \frac{1}{sin δ ( λ )} ) & ( 8 d )\end{matrix}$$

Since the left side of each of the expressions (6a) to (6f) and the retardation delta(lambda) of the retarder 22 can be calculated, the Stokes parameters of the analysis target light can be calculated by substituting these values in the expressions (8a) to (8d).

The ellipticity epsilon(lambda) and the principal axis direction phi(lambda) of the analysis target light are expressed as follows using the Stokes parameters.

$$\begin{matrix}ɛ ( λ ) = tan ( \frac{1}{2} arc tan ( \frac{{s}_{3}}{\sqrt{{s}_{1}^{2} + {s}_{2}^{2}}} ) ) & ( 9 a ) \\ φ ( λ ) = \frac{1}{2} arc tan \frac{{s}_{2} ( λ )}{{s}_{1} ( λ )} & ( 9 b )\end{matrix}$$

According to the principle employed in the invention, the polarization characteristic elements of the analysis target light having a wavelength lambda can thus be calculated so that the polarization characteristics (polarization state) of the analysis target light having a wavelength lambda can be measured. Specifically, the polarization characteristics of the analysis target light can be measured over the entire wavelength range even when utilizing a retarder of which the retardation has wavelength dependence.

### 2-2: Utilization of Measured Values

The left sides of the expressions (6a) to (6f) (i.e., a₀(lambda), a₂ₜₕₑₜₐ₂(lambda), a₄ₜₕₑₜₐ₁₋₂ₜₕₑₜₐ₂(lambda), b₂ₜₕₑₜₐ₂(lambda), b₂ₜₕₑₜₐ₁₋₂ₜₕₑₜₐ₂(lambda), and b₄ₜₕₑₜₐ₁₋₂ₜₕₑₜₐ₂(lambda)) indicate the bias component, the cos components, and the sin components of the light intensity. Specifically, these components are Fourier coefficients. Therefore, these coefficients can be calculated as follows.

$$\begin{matrix}{a}_{0} ( λ ) = \frac{1}{360} {\int }_{0}^{360} I ( λ , {θ}_{1} , {θ}_{2} ) d θ & ( 10 ) \\ {a}_{n} ( λ ) = \frac{1}{180} {\int }_{0}^{360} I ( λ , {θ}_{1} , {θ}_{2} ) cos ( n θ ) d θ & ( 11 ) \\ {b}_{n} ( λ ) = \frac{1}{180} {\int }_{0}^{360} I ( λ , {θ}_{1} , {θ}_{2} ) sin ( n θ ) d θ & ( 12 )\end{matrix}$$

Specifically, the left sides of the expressions (6a) to (6f) (i.e., a₀(lambda), a₂ₜₕₑₜₐ₂(lambda), a₄ₜₕₑₜₐ₁₋₂ₜₕₑₜₐ₂(lambda), b₂ₜₕₑₜₐ₂(lambda), b₂ₜₕₑₜₐ₁₋₂ₜₕₑₜₐ₂(lambda), and b₄ₜₕₑₜₐ₁₋₂ₜₕₑₜₐ₂(lambda)) can be calculated as numerical values utilizing the light intensity information (light intensity measured value).

The Stokes parameters can be calculated by the expressions (7) and (8a) to (8d) utilizing these values.

The ellipticity and the principal axis direction can be calculated as numerical values by the expressions (9a) and (9b) utilizing the Stokes parameters.

### 2-3: Principal Axis Direction Conditions Satisfied by Retarder 22 and Analyzer 24

The theoretical expression for the light intensity of the modulated light is given by the expression (5), as described above. However, all of the Stokes parameters s₀(lambda), s₁(lambda), s₂(lambda), and s₃(lambda) may not necessarily be calculated depending on the principal axis direction theta₁ of the retarder 22 and the principal axis direction theta₂ of the analyzer 24.

For example, the fourth term of the expression (5) becomes zero in the theoretical expression for the light intensity of light modulated by the modulation section in which the principal axis direction of the retarder 22 and the principal axis direction of the analyzer 24 satisfy the relationship 2theta₁-2theta₂=0. As a result, the Stokes parameter s₃(lambda) cannot be calculated even if the resulting light intensity is analyzed. Specifically, the principal axis direction of the retarder 22 and the principal axis direction of the analyzer 24 must satisfy the condition 2theta₁-2theta₂≠0 in order to calculate the Stokes parameter s₃(lambda).

The principal axis direction of the retarder 22 and the principal axis direction of the analyzer 24 must satisfy the conditions 2theta₁-2theta₂≠0, 4theta₁-2theta₂≠0, and 2theta₁-2theta₂≠4theta₁-2theta₂≠2theta₂ in order to calculate all of the Stokes parameters.

Specifically, all of the Stokes parameters can be calculated when the principal axis direction of the retarder 22 and the principal axis direction of the analyzer 24 satisfy the above-mentioned relationship. This enables an efficient measurement process.

Specifically, the light intensity information acquisition section 30 may acquire the light intensity information about the modulated light obtained by modulating the analysis target light at the modulation section 20 in which the principal axis direction theta₁ of the retarder 22 and the principal axis direction theta₂ of the analyzer 24 satisfy the relationship 3theta₁=theta₂. According to this configuration, since the retarder 22 and the analyzer 24 can satisfy the above-mentioned conditions, all of the Stokes parameters can be calculated.

For example, the light intensity information may be acquired in a constant cycle while rotating the retarder 22 and the analyzer 24 at a rotation ratio of 1:3. This makes it possible to efficiently acquire light intensity information that enables calculation of all of the Stokes parameters.

### 3. Measurement Process

A polarization state measurement process using the measuring apparatus according to this embodiment is described below.

FIGS. 4 and 5 are flowcharts showing the operation of the measuring apparatus according to this embodiment.

### 3-1: Light Intensity Information Acquisition Process

FIG. 4 is a flowchart showing a light intensity information acquisition process.

In the light intensity information acquisition process, the principal axis directions of the retarder 22 and the analyzer 24 (modulation section 20) are set (step S10).

Light is then emitted from the light source 12, and the light-receiving section 14 receives light (modulated light) modulated by the optical elements and the sample 100. The light intensity information acquisition section 30 acquires the light intensity information about the light (modulated light) received by the light-receiving section 14 (step S12).

In the light intensity information acquisition process, the light intensity information acquisition section 30 acquires the light intensity information about a plurality of types of modulated light (light intensity information about first modulated light to Nth modulated light). The first modulated light to the Nth modulated light are measurement light obtained by modulating the analysis target light at the modulation section 20 set in the first to Nth principal axis direction conditions, respectively. In the light intensity information acquisition process, the steps S10 and S12 are repeated a plurality of times while changing the principal axis directions of the optical elements.

Specifically, the measuring apparatus 1 acquires the first light intensity information while setting the principal axis directions of the optical elements to satisfy the first condition. The measuring apparatus 1 then relates the first light intensity information to the first condition (principal axis direction information) and stores them in the above-described storage device 40. The measuring apparatus 1 then acquires the second light intensity information while setting (changing) the principal axis directions of the optical elements to satisfy the second condition, relates the second light intensity information to the second condition, and stores them in the storage device 40. The measuring apparatus 1 may repeat the above-described operation to acquire N pieces of principal axis direction information and N pieces of light intensity information, relate the N pieces of principal axis direction information to the N pieces of light intensity information, and store them in the storage device 40.

The principal axis directions of the optical elements of the optical system may be set (changed) by causing the control signal generation section 65 to operate the actuators of the oparationr/detection sections 62 and 64. The principal axis direction information about the optical elements of the optical system may be detected by the detection section, or may be information programmed in advance.

### 3-2: Calculation Process

FIG. 5 is a flowchart showing a calculation process. In the calculation process, the polarization characteristic elements of the analysis target light are calculated based on the light intensity information about the modulated light acquired by the light intensity information acquisition process and the theoretical expression for the modulated light.

In the calculation process, the values a₀(lambda), a₂ₜₕₑₜₐ₂(lambda), a₄ₜₕₑₜₐ₁₋₂ₜₕₑₜₐ₂(lambda), b₂ₜₕₑₜₐ₂(lambda), b₂ₜₕₑₜₐ₁₋₂ₜₕₑₜₐ₂(lambda), and b₄ₜₕₑₜₐ₁₋₂ₜₕₑₜₐ₂(lambda) are calculated based on the expressions (10) to (12) (step S20).

The retardation delta(lambda) of the retarder 22 and the Stokes parameters s₀(lambda), s₁(lambda), s₂(lambda), and s₃(lambda) of the analysis target light are then calculated based on the expressions (7) and (8a) to (8d) (step S22).

The ellipticity epsilon(lambda) and the principal axis direction phi(lambda) of the analysis target light are calculated based on the expressions (9a) and (9b) utilizing the Stokes parameters of the analysis target light (step S24).

The ellipticity and the principal axis direction (i.e., polarization characteristic elements) of the analysis target light can be calculated by the above-mentioned process so that the polarization state of the analysis target light can be measured.

4. Retardation delta(lambda) of Retarder 22

According to the measuring apparatus 1, since the retardation delta(lambda) of the retarder 22 can be calculated based on the expression (7) even when using a retarder of which the retardation is unknown, as described above, the Stokes parameters of the analysis target light can be calculated using the retardation delta(lambda) of the retarder 22.

However, the retardation delta(lambda) cannot be calculated using the expression (7) when the Stokes parameters of the analysis target light are Sᵢₙ={s₀(lambda), s₁(lambda), s₂(lambda), s₃(lambda)}={1, 0, 0, 1}. In order to avoid such a situation, the retardation delta(lambda) of the retarder 22 may be calculated in advance to obtain calibration data, and the measurement may be carried out using the resulting value.

Specifically, the light intensity information acquisition process may be performed while causing sample light of which the Stokes parameters are not {1, 0, 0, 1} to be incident on the modulation section 20 instead of the analysis target light, and the retardation delta(lambda) may be calculated as calibration data based on the acquired light intensity information and the light intensity theoretical expression (refer to the expression (7)). The retardation delta(lambda) calculated by this process may be stored in the storage device 40, and the above-described polarization characteristic element calculation process may be performed utilizing the retardation delta(lambda) stored in the storage device 40.

Since the retardation delta(lambda) is a value specific to the retarder 22, the retardation delta(lambda) is calculated and stored in the storage device 40. Therefore, the retardation delta(lambda) need not be calculated thereafter so that the calculation efficiency can be improved.

### 5. Modification

A measuring apparatus according to a modification of the embodiment to which the invention is applied is described below. The above description is applied to this embodiment as far as possible.

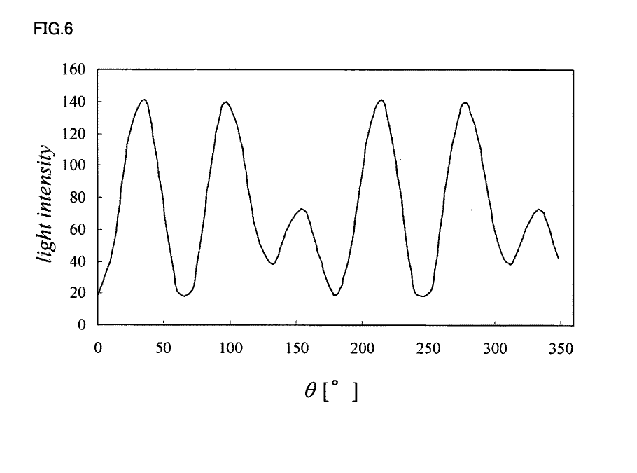

In the measuring apparatus according to this embodiment, the light intensity information acquisition section 30 acquires the light intensity information about modulated light obtained by modulating the analysis target light at the modulation section 20 of which the retarder 22 and the analyzer 24 are rotated at a given rotation ratio. According to this measuring apparatus, the light intensity information acquisition section 30 can acquire the light intensity information about the modulated light of which the intensity changes successively as analog information, as shown in FIG. 6.

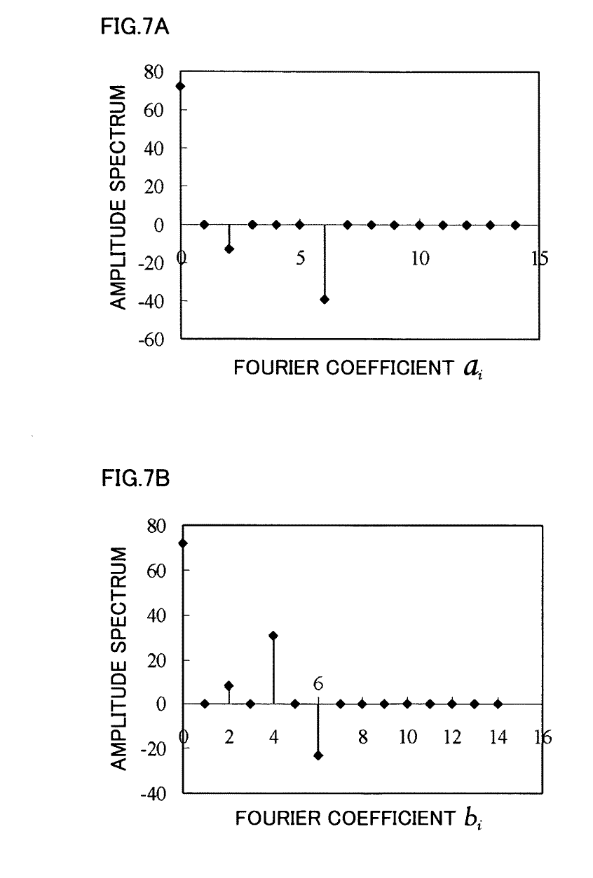

The light intensity may be considered to be a function having a cycle, as shown in FIG. 6. Therefore, the spectral peak can be extracted by subjecting the light intensity to an analysis process (e.g., Fourier analysis process), as shown in FIG. 7. The Stokes parameters of the analysis target light can be calculated based on the expressions (8a) to (8d) by applying these spectral peaks to the light intensity theoretical expression (the left sides of the expressions (6a) to (6f)).

### 6. Verification Results

A verification experiment for confirming the measurement principle according to the invention and its accuracy was conducted. The results are given below.

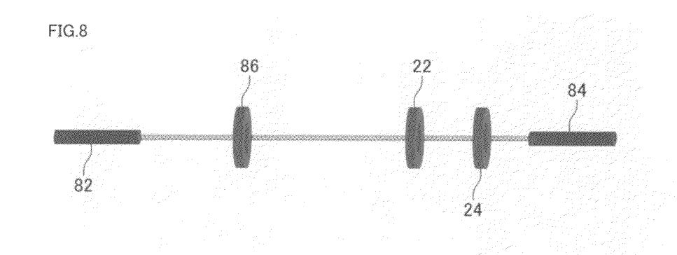

A single wavelength measurement using a helium neon laser (633 nm) was conducted. In this experiment, as shown in FIG. 8, a polarizer 86, the retarder 22, and the analyzer 24 were disposed between a helium neon laser light source 82 and a power meter 84 (light-receiving section 14 and light intensity information acquisition section 30). The principal axis direction of the polarizer 86 was set at 0°. The retarder 22 was rotated at intervals of 12°. The retarder 22 and the analyzer 24 were rotated at a rotation ratio of 1 to 3. A quarter-wave plate for a helium neon laser (633 nm) was used as the retarder 22.

In this experiment, the birefringence, the principal axis direction, and the ellipticity of the retarder 22 were respectively 90°, −0.15°, and 0.1%.

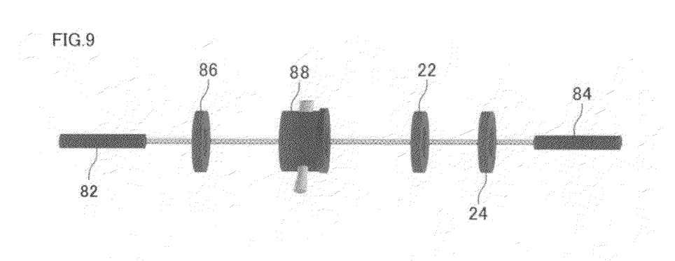

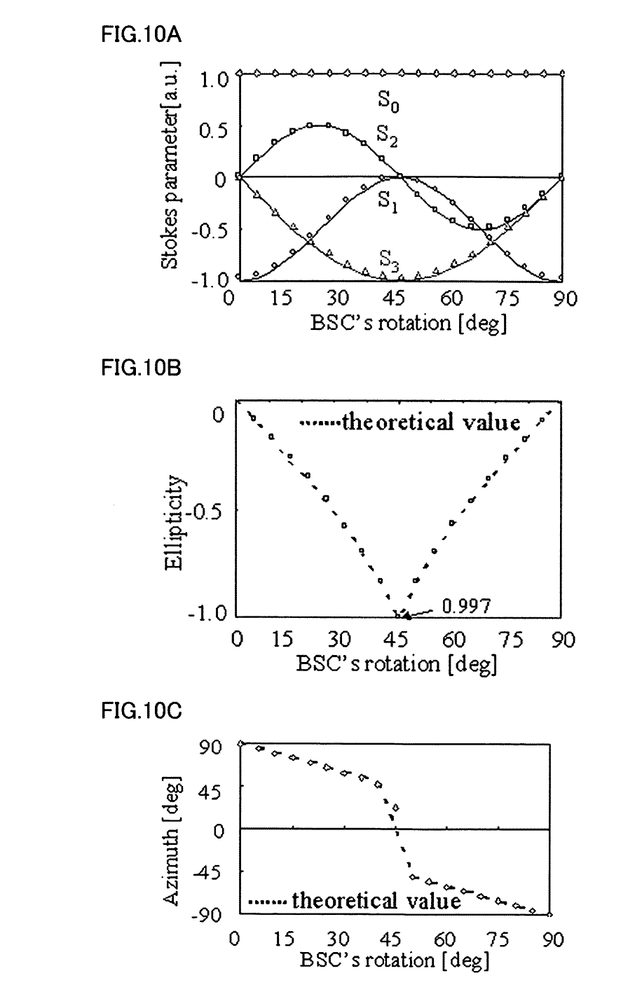

A sample was placed as shown in FIG. 9, and the ellipticity was measured. In this experiment, a Babinet Soleil compensator 88 was used as the sample. The Babinet Soleil compensator 88 is an optical element (device) of which the retardation can be arbitrarily adjusted. FIGS. 10A to 10C shows the results for Stokes parameters, ellipticity, and principal axis direction measured by this experiment. This experiment was conducted while changing the principal axis direction of the Babinet Soleil compensator 88 from 0° to 90° at intervals of 5°. In FIGS. 10A to 10C, a solid line and a broken line indicate theoretical values, and plotted points indicate measurement results.

As shown in FIGS. 10A to 10C, results equivalent to the theoretical values were obtained for the Stokes parameters and the ellipticity. It was found that the measurement accuracy was 0.3% even when the birefringence of the sample was about 90°. The principal axis direction measurement results differed from the theoretical value when the rotation angle of the Babinet Soleil compensator 88 was about 45°. It is considered that the above difference occurred due to 99.7% circularly polarized light.

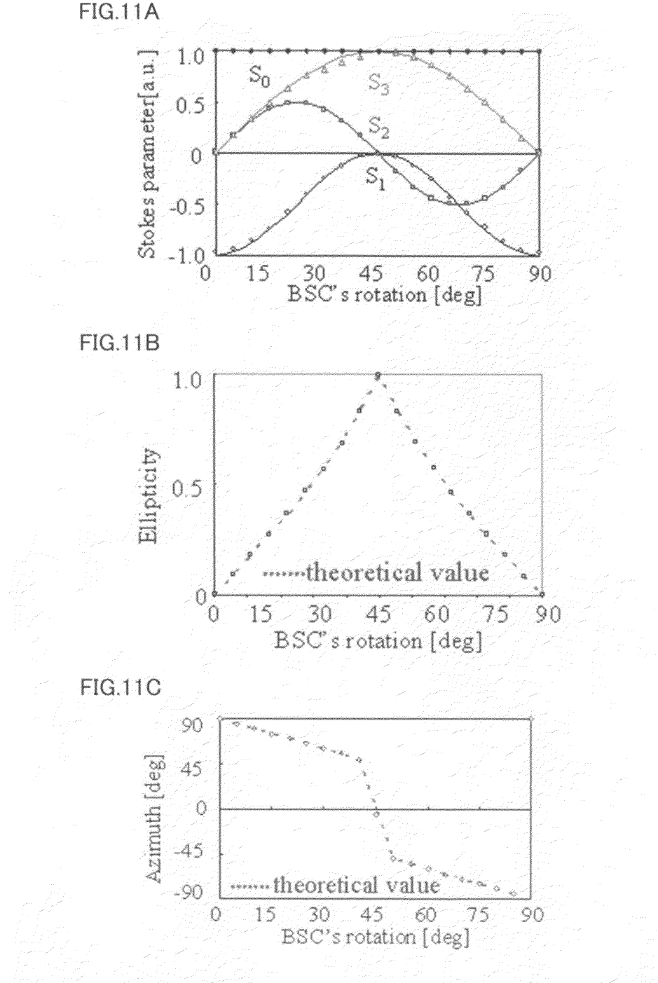

The same experiment was conducted using another retarder in order to verify whether or not replacement of the phaser is necessary. In this experiment, a quarter-wave plate at a wavelength of 457 nm was used as the retarder 22. The quarter-wave plate at a wavelength of 457 nm has a birefringence of about 65° for light having a wavelength of 633 nm. Therefore, whether or not the polarization state can be measured even when the amount of modulation by the retarder is not 90° can be determined. The experimental results are shown in FIGS. 11A to 11C.

As shown in FIGS. 11A to 11C, results similar to the theoretical value were obtained for the Stokes parameters, ellipticity, and principal axis direction. This confirms that the polarization characteristics can be measured by the invention irrespective of the amount of phase modulation by the retarder 22. From the experimental results, it is considered that the polarization characteristic can be measured even when using a light source at a wavelength of 457 nm and a quarter-wave plate at a wavelength of 633 nm.

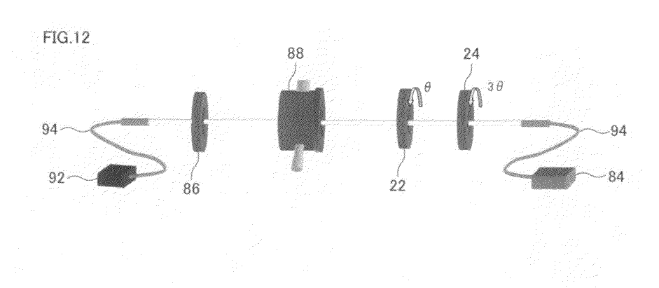

An experiment utilizing light in a multi-wavelength band was then conducted. FIG. 12 shows an experimental device used for this experiment.

As shown in FIG. 12, a halogen lamp used as a light source 92. Light from the light source 92 was guided through an optical fiber 94, and parallel light was created using a collimating lens. The Babinet Soleil compensator 88 was used as a sample in the same manner as in the single wavelength experiment. A mica plate was used as the retarder 22. The halogen lamp was a white light source that emitted light over a wavelength region of 400 nm to 800 nm. A halogen lamp generally shows a weak light intensity in an edge wavelength region of 400 nm to 440 nm and 700 nm to 800 nm. Therefore, the measurement wavelength region was set at 450 nm to 660 nm.

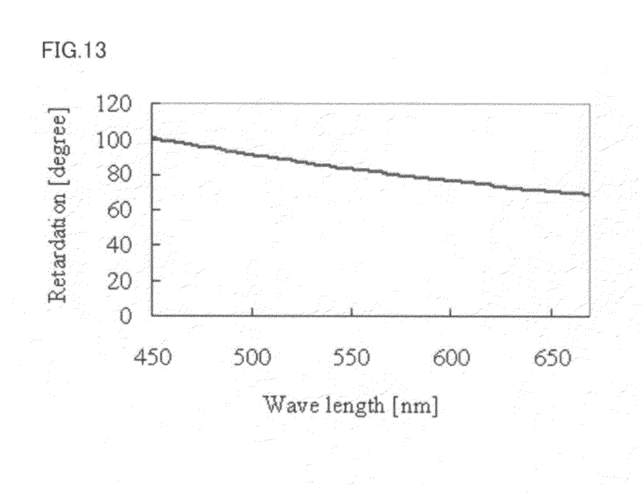

In the measurement, the retardation of the retarder 22 was determined to obtain calibration data. The calibration data was obtained using the experimental device without the Babinet Soleil compensator 88 by modulating the phase of light that passed through the polarizer 86 using the retarder 22 (mica plate) and analyzing the light intensity waveform in the same manner as in the measurement using a helium neon laser. FIG. 13 shows the birefringence dispersion of the mica plate obtained by the calibration.

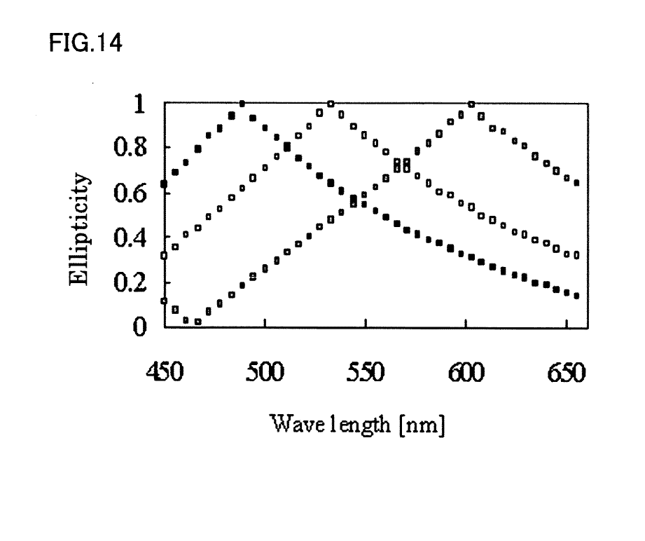

The sample (Babinet Soleil compensator 88) was then inserted, and the ellipticity was measured in the multi-wavelength region. In this experiment, the Babinet Soleil compensator 88 was provided at an principal axis direction 45°, and a circularly polarized state was created at an arbitrary wavelength. The retardation of the Babinet Soleil compensator 88 was changed by changing the micrometer so that the wavelength of the circularly polarized state was shifted. FIG. 14 shows the results obtained by changing the retardation of the Babinet Soleil compensator by changing the micrometer. The retarder 22 was rotated at intervals of 12°. In FIG. 14, the results are plotted at wavelength intervals of 5 nm.

An ellipticity equal to or higher than 99% was obtained for each result. It is considered that an ellipticity of 100% would be obtained by more accurately installing the Babinet Soleil compensator and more accurately rotating the detection system.

As is clear from the experimental results, it was found that the ellipticity can be accurately measured by the measuring apparatus according to the invention without replacing the retarder 22 even when utilizing light in a multi-wavelength region.

The invention is not limited to the above-described embodiments. Various modifications and variations may be made. The invention includes configurations substantially the same as the configurations described in the above-described embodiments (in function, in method and effect, or in objective and effect). The invention also includes a configuration in which an unsubstantial section of the above-described embodiments is replaced by another section. The invention also includes a configuration having the same effects as those of the above-described configurations, or a configuration capable of achieving the same object as those of the above-described configurations. Further, the invention includes a configuration obtained by adding known technology to the above-described configurations.

For example, the modulation section 20 (retarder 22 and analyzer 24) may be configured so that the principal axis direction can be changed manually. In this case, the calculation process may be performed based on the principal axis direction information acquired by the detection section.

The above embodiments have been described taking the calculation process utilizing a Mueller matrix as an example. Note that the invention may be applied to a calculation process utilizing a Jones matrix.

According to the invention, the polarization state of the analysis target light can be measured and determined. Therefore, the invention may be applied to light of which the polarization state is unknown to measure the polarization state. Specifically, the polarization state can be measured irrespective of the characteristics of the measurement sample. That is, the polarization state can be measured irrespective of the configuration on the upstream side of the retarder 22 in the optical system 10 (optical path L).

The measuring apparatus (measuring method) according to the invention may be configured as a measuring apparatus (measuring method) that measures the optical characteristic elements (e.g., retardation, principal axis direction, optical activity, Stokes parameters, Mueller matrix elements, and Jones matrix elements) of the sample 100. The optical characteristic elements of the sample 100 can be calculated by appropriately selecting the characteristics of the light source and the optical element placed between the light source and the sample 100.

The invention may be utilized for evaluation of organic polymer materials such as a liquid crystal and research and development of new materials. The invention may also be applied to quality control of a polymer orientation state. Findings obtained therefrom are very effective for development of new materials.

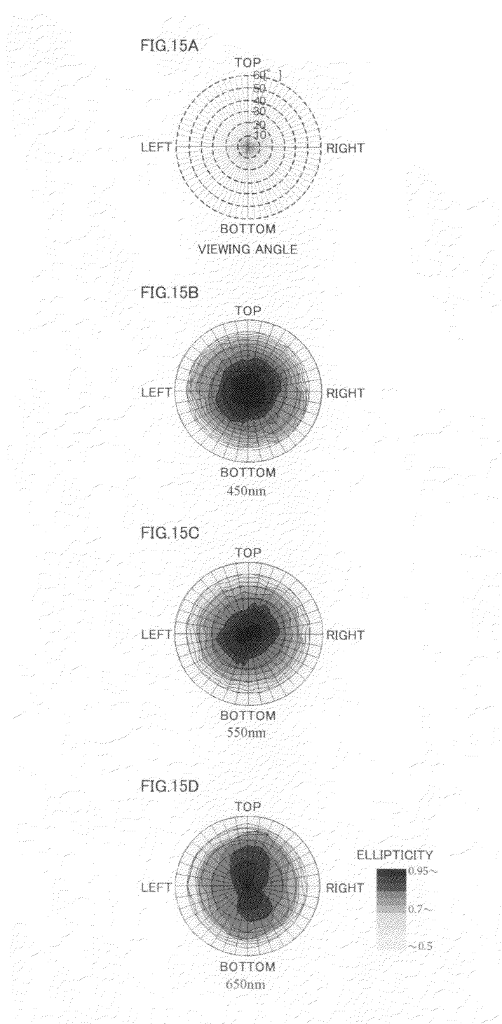

FIGS. 15A to 15D show viewing angle characteristic evaluation results for a circular polarizer film obtained using the invention. FIG. 15A shows a viewing angle distribution display model. FIGS. 15B to 15D are views showing the ellipticity measurement results for light (analysis target light) having a wavelength of 450 nm, 550 nm, and 650 nm emitted from the measurement target (sample 100), respectively. The grey level in each drawing indicates the degree of ellipticity.

According to the invention, the ellipticity viewing angle distribution of light (analysis target light) emitted from the measurement target can be detected as shown in FIGS. 15B to 15D.

As is clear from the results shown in FIGS. 15B to 15D, the measurement target used in this experiment had an ellipticity viewing angle distribution that differed depending on the wavelength. As shown in FIG. 15B, the ellipticity was almost uniform in the vertical and horizontal directions when the wavelength was 450 nm. As shown in FIG. 15D, the ellipticity in the vertical direction was high and the ellipticity in the horizontal direction was low when the wavelength was 650 nm.

According to the invention, the ellipticity distribution of the measurement target (i.e., the polarization state of the analysis target light) corresponding to each wavelength band can be efficiently and accurately measured, as shown in FIGS. 15B to 15D.

1. A measuring apparatus that measures a polarization state of analysis target light, the measuring apparatus comprising:
a modulation section including a retarder and an analyzer that are rotatable at a given integral rotation ratio and modulating the analysis target light, the retarder having a retardation that has wavelength dependence;
a light intensity information acquisition section that acquires light intensity information about modulated light, the modulated light being obtained by modulating the analysis target light by rotation of the retarder and the analyzer of the modulation section at the integral rotation ratio; and
a calculation section that calculates a polarization characteristic element of the analysis target light based on the light intensity information about the modulated light,
the analysis target light passing through the retarder and then passing through the analyzer in the modulation section;
the light intensity information acquisition section acquiring the light intensity information about first modulated light to Nth (N is an integer equal to or larger than two) modulated light respectively obtained by modulating the analysis target light at the modulation section set under first to Nth principal axis direction conditions which differ in the principal axis direction of at least one of the retarder and the analyzer; and
the calculation section calculating all of Stokes parameters related to the polarization characteristic element, while reflecting the wavelength dependence of the retardation of the retarder, based on a light intensity theoretical expression for the first modulated light to the Nth modulated light and the light intensity information about the first modulated light to the Nth modulated light, the light intensity theoretical expression reflecting the polarization characteristic element of the analysis target light and the principal axis direction conditions for the modulation section.

2. A measuring apparatus that measures a polarization state of analysis target light, the measuring apparatus comprising:
a light intensity information acquisition section that acquires light intensity information about modulated light obtained by modulating the analysis target light by rotation of a retarder and an analyzer at a given integral rotation ratio, the retarder and the analyzer being included in a modulation section, and the retarder having a retardation that has wavelength dependence; and
a calculation section that calculates a polarization characteristic element of the analysis target light based on the light intensity information about the modulated light,
the modulated light being light obtained by causing the analysis target light to pass through the retarder and then pass through the analyzer;
the light intensity information acquisition section acquiring the light intensity information about first modulated light to Nth (N is an integer equal to or larger than two) modulated light respectively obtained by modulating the analysis target light at the modulation section set under first to Nth principal axis direction conditions which differ in the principal axis direction of at least one of the retarder and the analyzer; and
the calculation section calculating all of Stokes parameters related to the polarization characteristic element, while reflecting the wavelength dependence of the retardation of the retarder, based on a light intensity theoretical expression for the first modulated light to the Nth modulated light and the light intensity information about the first modulated light to the Nth modulated light, the light intensity theoretical expression reflecting the polarization characteristic element of the analysis target light and the principal axis direction conditions for the modulation section.

3. A measuring apparatus that measures a polarization state of analysis target light, the measuring apparatus comprising:
a modulation section including a retarder and an analyzer that are rotatable at a given integral rotation ratio and modulating the analysis target light, the retarder having a retardation that has wavelength dependence;
a light intensity information acquisition section that acquires light intensity information about modulated light, the modulated light being obtained by modulating the analysis target light by rotation of the retarder and the analyzer of the modulation section at the integral rotation ratio; and
a calculation section that calculates a polarization characteristic element of the analysis target light based on the light intensity information about the modulated light,
the analysis target light passing through the retarder and then passing through the analyzer in the modulation section;
the light intensity information acquisition section acquiring the light intensity information about the modulated light as analog information, the intensity of the modulated light changing successively; and
the calculation section calculating all of Stokes parameters related to the polarization characteristic element, while reflecting the wavelength dependence of the retardation of the retarder, based on a light intensity theoretical expression for the modulated light and the light intensity information about the modulated light, the light intensity theoretical expression reflecting the polarization characteristic element of the analysis target light and a principal axis direction condition for the modulation section.

4. A measuring apparatus that measures a polarization state of analysis target light, the measuring apparatus comprising:
a light intensity information acquisition section that acquires light intensity information about modulated light obtained by modulating the analysis target light by rotation of a retarder and an analyzer at a given integral rotation ratio, the retarder and the analyzer being included in a modulation section, and the retarder having a retardation that has wavelength dependence; and
a calculation section that calculates a polarization characteristic element of the analysis target light based on the light intensity information about the modulated light,
the modulated light being light obtained by causing the analysis target light to pass through the retarder and then pass through the analyzer;
the light intensity information acquisition section acquiring the light intensity information about the modulated light as analog information, the intensity of the modulated light changing successively; and
the calculation section calculating all of Stokes parameters related to the polarization characteristic element, while reflecting the wavelength dependence of the retardation of the retarder, based on a light intensity theoretical expression for the modulated light and the light intensity information about the modulated light, the light intensity theoretical expression reflecting the polarization characteristic element of the analysis target light and a principal axis direction condition for the modulation section.

5. The measuring apparatus as defined in claim 1,
wherein the calculation section calculates all of the Stokes parameters related to the polarization characteristic element, while reflecting the wavelength dependence of the retardation of the retarder, based on a plurality of spectral peaks obtained by analyzing the light intensity information acquired by the light intensity information acquisition section and the light intensity theoretical expression.

6. The measuring apparatus as defined in claim 1,
wherein the calculation section performs a retardation calculation process before calculating the Stokes parameters, the retardation calculation process calculating the retardation of the retarder based on the light intensity theoretical expression and light intensity information about modulated light obtained by modulating sample light that shows a predetermined polarization state, instead of the analysis target light, by using the modulation section, and
wherein the calculation section then calculates all of the Stokes parameters related to the polarization characteristic element, while reflecting the wavelength dependence of the retardation of the retarder, based on the retardation of the retarder calculated by the retardation calculation process.

7. The measuring apparatus as defined in claim 1, wherein the integral rotation ratio is 1 to 3.

8. The measuring apparatus as defined in claim 1,
wherein the calculation section calculates at least one of ellipticity of the analysis target light and a principal axis direction of the analysis target light.

9. The measuring apparatus as defined in claim 1, further comprising:
a first actuator and a second actuator that rotate the retarder and the analyzer;
a first detection section and a second detection section that detect the principal axis directions of the retarder and the analyzer; and
a control signal generation section that generates a control signal that controls operations of the first actuator and the second actuator,
wherein the control signal generation section generates the control signal based on detection signals from the first detection section and the second detection section.

10. A measuring method of measuring a polarization state of analysis target light, the measuring method comprising:
a light intensity information acquisition step of acquiring light intensity information about modulated light obtained by modulating the analysis target light by rotation of a retarder and an analyzer at a given integral rotation ratio, the retarder and the analyzer being included in a modulation section, and the retarder having a retardation that has wavelength dependence; and
a calculation step of calculation a polarization characteristic element of the analysis target light based on the light intensity information about the modulated light,
the modulated light being light obtained by causing the analysis target light to pass through the retarder and then pass through the analyzer;
the light intensity information acquisition step acquiring the light intensity information about first modulated light to Nth (N is an integer equal to or larger than two) modulated light respectively obtained by modulating the analysis target light at the modulation section set under first to Nth principal axis direction conditions which differ in the principal axis direction of at least one of the retarder and the analyzer; and
the calculation step calculating all of Stokes parameters related to the polarization characteristic element, while reflecting the wavelength dependence of the retardation of the retarder, based on a light intensity theoretical expression for the first modulated light to the Nth modulated light and the light intensity information about the first modulated light to the Nth modulated light, the light intensity theoretical expression reflecting the polarization characteristic element of the analysis target light and the principal axis direction conditions for the modulation section.

11. A measuring method of measuring a polarization state of analysis target light, the measuring method comprising:
a light intensity information acquisition step of acquiring light intensity information about modulated light obtained by modulating the analysis target light by rotation of a retarder and an analyzer at a given integral rotation ratio, the retarder and the analyzer being included in a modulation section, and the retarder having a retardation that has wavelength dependence; and
a calculation step of calculation a polarization characteristic element of the analysis target light based on the light intensity information about the modulated light,
the modulated light being light obtained by causing the analysis target light to pass through the retarder and then pass through the analyzer;
the light intensity information acquisition step acquiring the light intensity information about the modulated light as analog information, the intensity of the modulated light changing successively; and
the calculation step calculating all of Stokes parameters related to the polarization characteristic element, while reflecting the wavelength dependence of the retardation of the retarder, based on a light intensity theoretical expression for the modulated light and the light intensity information about the modulated light, the light intensity theoretical expression reflecting the polarization characteristic element of the analysis target light and a principal axis direction condition for the modulation section.

12. The measuring method as defined in claim 10,
wherein the calculation step calculates all of the Stokes parameters related to the polarization characteristic element, while reflecting the wavelength dependence of the retardation of the retarder, based on a plurality of spectral peaks obtained by analyzing the light intensity information acquired in the light intensity information acquisition step and the light intensity theoretical expression.

13. The measuring method as defined in claim 10, further comprising:
a retardation calculation step before calculating the Stokes parameters, the retardation calculation step acquiring light intensity information about modulated light obtained by modulating sample light that shows a predetermined polarization state, instead of the analysis target light, by using the modulation section, and calculating the retardation of the retarder based on the acquired light intensity information and the light intensity theoretical expression,
wherein the calculation step calculates all of the Stokes parameters related to the polarization characteristic element, while reflecting the wavelength dependence of the retardation of the retarder, based on the retardation of the retarder calculated in the retardation calculation step.

14. The measuring method as defined in claim 10, wherein the integral rotation ratio is 1 to 3.

15-17. (canceled)

18. The measuring apparatus as defined in claim 2,
wherein the calculation section calculates all of the Stokes parameters related to the polarization characteristic element, while reflecting the wavelength dependence of the retardation of the retarder, based on a plurality of spectral peaks obtained by analyzing the light intensity information acquired by the light intensity information acquisition section and the light intensity theoretical expression.

19. The measuring apparatus as defined in claim 3,
wherein the calculation section calculates all of the Stokes parameters related to the polarization characteristic element, while reflecting the wavelength dependence of the retardation of the retarder, based on a plurality of spectral peaks obtained by analyzing the light intensity information acquired by the light intensity information acquisition section and the light intensity theoretical expression.

20. The measuring apparatus as defined in claim 4,
wherein the calculation section calculates all of the Stokes parameters related to the polarization characteristic element, while reflecting the wavelength dependence of the retardation of the retarder, based on a plurality of spectral peaks obtained by analyzing the light intensity information acquired by the light intensity information acquisition section and the light intensity theoretical expression.

21. The measuring method as defined in claim 11,
wherein the calculation step calculates all of the Stokes parameters related to the polarization characteristic element, while reflecting the wavelength dependence of the retardation of the retarder, based on a plurality of spectral peaks obtained by analyzing the light intensity information acquired in the light intensity information acquisition step and the light intensity theoretical expression.

22. The measuring method as defined in claim 11, further comprising:
a retardation calculation step before calculating the Stokes parameters, the retardation calculation step acquiring light intensity information about modulated light obtained by modulating sample light that shows a predetermined polarization state, instead of the analysis target light, by using the modulation section, and calculating the retardation of the retarder based on the acquired light intensity information and the light intensity theoretical expression,
wherein the calculation step calculates all of the Stokes parameters related to the polarization characteristic element, while reflecting the wavelength dependence of the retardation of the retarder, based on the retardation of the retarder calculated in the retardation calculation step.

23. The measuring method as defined in claim 11, wherein the integral rotation ratio is 1 to 3.
